(19) United States
(12) Patent Application Publication
(10) Pub. No.: US 2015/0173564 A1
(43) Pub. Date: Jun. 25, 2015

(54) Metal Detectable Liquid Crytalline Polymer Composition

(71) Applicant: Ticona LLC, Florence, KY (US)

(72) Inventors: Paul C. Yung, Cincinnati, OH (US); Oliver Juenger, Mainz (DE)

(21) Appl. No.: 14/569,934

(22) Filed: Dec. 15, 2014

Related U.S. Application Data
(60) Provisional application No. 61/918,699, filed on Dec. 20, 2013.

(51) Int. Cl. A47J 36/02; C08K 3/10; C08K 3/34

(52) U.S. Cl. CPC A47J 36/025; C08K 3/34; C08K 3/10

(57) ABSTRACT

A melt-extrudable polymer composition that contains a thermotropic liquid crystalline polymer, non-metallic filler, and metallic filler is provided. The composition is particularly well suited for forming cooking articles (e.g., cookware, bakeware, etc.). When incorporated into such an article, for instance, the metallic filler in polymer composition can be readily detected (e.g., by a metal detector), which in turn allows any foodstuffs prepared with the article to be tested for possible contamination. In addition, the specific nature of the liquid crystalline polymer and relative concentration of the non-metallic and metallic fillers are also selectively controlled so that the resulting composition can possess a relatively high degree of melt viscosity and/or melt strength, which allows the composition to better maintain its shape during melt extrusion.

### RELATED APPLICATIONS

The present application claims priority to U.S. Provisional Application Ser. No. 61/918,699, filed on Dec. 20, 2013, which is incorporated herein in its entirety by reference thereto.

### BACKGROUND OF THE INVENTION

Many baked goods, such as rolls, cookies, pizzas, etc., are baked on cookware or bakeware. The bakeware can be flat, such as a baking sheet, or can be shaped, such as bakeware containing domed portions or cavities. Conventional cookware and bakeware articles have been made from metals. For example, aluminum, copper, cast iron, and stainless steel have all been used to produce the above described articles. Unfortunately, food stuffs have a tendency to stick to metal surfaces, particularly at the seams. To remedy this problem, modern metal cooking pans and baking pans are frequently coated with a substance that minimizes the possibility of food sticking to the surface of the utensil. Coatings that have been used in the past include, for instance, polytetrafluoroethylene (PTFE) or silicone. Although these coatings can deliver non-stick properties, they have a tendency to break down, peel off, and degrade over time requiring either replacement or periodic recoating of the metal cookware and bakeware. In addition, the process for producing polytetrafluoroethylene has recently come under scrutiny due to possible health hazards related to various components used to produce the product. Furthermore, metal bakeware also tends to be relatively heavy and can corrode. Metal bakeware can also produce loud and noisy sounds when handled in a large volume.

In the past, the use of nonmetallic materials has been investigated for cookware and bakeware articles. For example, wholly aromatic polyester resins have been produced that inherently possess good anti-stick properties. However, the food processing industry has been reluctant to switch to non-metallic materials. One advantage to using metallic cooking utensils, for instance, is that the food prepared can be fed through metal detectors to ensure that the food product is metal-free and has not been contaminated by the cookware or bakeware used to prepare the product. Polymeric materials, on the other hand, are not as easily detectable. Switching to polymeric materials thus may require food processors to switch to a completely different contamination control program and procurement of new detection equipment such as X-ray.

As such, a need currently exists for an improved liquid crystalline polymer composition that can be formed into cookware and bakeware and that has inherently good non-stick properties, temperature stability, and impact performance and is detectable by existing metal detectors used in bakeries and by the food processing industry.

### SUMMARY OF THE INVENTION

In accordance with one embodiment of the present invention, a metal detectable, melt-extrudable polymer composition is disclosed that comprises from about 25 wt. % to about 98 wt % of a thermotropic liquid crystalline polymer, from about 1 wt. % to about 60 wt. % of a non-metallic filler, from about 1 wt. % to about 15 wt. % of a metallic filler. The polymer exhibits a melt viscosity of from about 20 to about 250 Pa−s, determined at a shear rate of 1000 s⁻¹ in accordance with ISO Test No, 11443 at 15° C. higher than the melting temperature of the composition.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a plan view of one embodiment of a cookware tray made in accordance with one embodiment of the present invention;

FIG. 2 is a side view of the cookware tray illustrated in FIG. 1;

FIG. 3 is an alternative embodiment of a cookware tray made in accordance with one embodiment of the present invention;

FIG. 4 is a side view of a process for forming extruded polymeric sheets in accordance with one embodiment of the present invention; and

FIG. 5 is a side view of a thermoforming process that may be employed in one embodiment of the present invention.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present invention.

Generally speaking, the present invention is directed to a melt-extrudable polymer composition that contains a thermotropic liquid crystalline polymer, non-metallic filler, and metallic filler. The composition is particularly well suited for forming cooking articles (e.g., cookware, bakeware, etc.). When incorporated into such an article, for instance, the metallic filler in polymer composition can be readily detected (e.g., by a metal detector), which in turn allows any foodstuffs prepared with the article to be tested for possible contamination. In addition, the specific nature of the liquid crystalline polymer and relative concentration of the non-metallic and metallic fillers are also selectively controlled so that the resulting composition can possess a relatively high degree of melt viscosity and/or melt strength, which allows the composition to better maintain its shape during melt extrusion without exhibiting a substantial amount of sag.

### I. Polymer Composition

A. Thermotropic Liquid Crystalline Polymer

As indicated above, the composition contains a thermotropic liquid crystalline polymer or blend of such polymers to achieve the desired properties. For example, thermotropic liquid crystalline polymers typically constitute from about 25 wt. % to about 98 wt. %, in some embodiments from about 30 wt. % to about 95 wt. %, and in some embodiments, from about 40 wt. % to about 90 wt % of the composition. Liquid crystalline polymers are generally classified as “thermotropic” to the extent that they can possess a rod-like structure and exhibit a crystalline behavior in its molten state (e.g., thermotropic nematic state). Such polymers may be formed from one or more types of repeating units as is known in the art. Liquid crystalline polymers may, for example, contain one or more aromatic ester repeating units, typically in an amount of from about 60 mol. % to about 99.9 mol. %, in some embodiments from about 70 mol. % to about 99.5 mol. %, and in some embodiments, from about 80 mol. % to about 99 mol. % of the polymer. The aromatic ester repeating units may be generally represented by the following Formula (I):

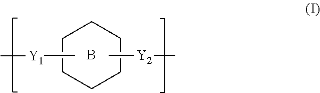

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ are C(O) in Formula I), aromatic hydroxycarboxylic repeating units (Y₁ is O and Y₂ is C(O) in Formula I), as well as various combinations thereof.

Aromatic dicarboxylic repeating units, for instance, may be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 5 mol. % to about 60 mol. %, in some embodiments from about 10 mol. % to about 55 mol. %, and in some embodiments, from about 15 mol. % to about 50 mol. % of a polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 10 mol. % to about 85 mol. %, in some embodiments from about 20 mol. % to about 80 mol. %, and in some embodiments, from about 25 mol. % to about 75 mol. % of a polymer.

Other repeating units may also be employed. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 30 mol. %, in some embodiments from about 2 mol. % to about 25 mol. %, and in some embodiments, from about 5 mol. % to about 20 mol. % of a polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol %, in some embodiments from about 0.5 mol. % to about 15 mol. %, and in some embodiments, from about 1 mol. % to about 10 mol. % of a polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, dials, amides, amines, etc. Of course, in other embodiments, the polymer may be “wholly aromatic” in that it lacks repeating units derived from non-aromatic (e.g., aliphatic or cycloaliphatic) monomers.

Although not necessarily required, liquid crystalline polymers may be “low naphthenic” to the extent that they contain a minimal content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) is typically no more than 30 mol. %, in some embodiments no more than about 15 mol. %, in some embodiments no more than about 10 mol. %, in some embodiments no more than about 8 mol. %, and in some embodiments, from 0 mol. % to about 5 mol. % of a polymer (e.g., 0 mol. %). Despite the absence of a high level of conventional naphthenic acids, it is believed that the resulting “low naphthenic” polymers are still capable of exhibiting good thermal and mechanical properties.

In one particular embodiment, for example, the polymer may be formed from repeating units derived from 4-hydroxybenzoic acid (“HBA”) and terephthalic acid (“TA”) and/or isophthalic acid (“IA”), as well as various other optional constituents. The repeating units derived from 4-hydroxybenzoic acid (“HBA”) may constitute from about 10 mol. % to about 80 mol. %, in some embodiments from about 30 mol. % to about 75 mol. %, and in some embodiments, from about 45 mol. % to about 70 mol. % of the polymer. The repeating units derived from terephthalic acid (“TA”) and/or isophthalic acid (“IA”) may likewise constitute from about 5 mol. % to about 40 mol. %, in some embodiments from about 10 mol. % to about 35 mol. %, and in some embodiments, from about 15 mol. % to about 35 mol. % of the polymer. Repeating units may also be employed that are derived from 4,4′-biphenol (“BP”) and/or hydroquinone (“HQ”) in an amount from about 1 mol. % to about 30 mol. %, in some embodiments from about 2 mol. % to about 25 mol. %, and in some embodiments, from about 5 mol. % to about 20 mol. % of the polymer. Other possible repeating units may include those derived from 6-hydroxy-2-naphthoic acid (“HNA”), 2,6-naphthalenedicarboxylic acid (“NDA”), and/or acetaminophen (“APAP”). For example, repeating units derived from HNA, NDA, and/or APAP may each constitute from about 1 mol. % to about 35 mol. %, in some embodiments from about 2 mol. % to about 30 mol. %, and in some embodiments, from about 3 mol. % to about 25 mol. % when employed.

Liquid crystalline polymers may be prepared by initially introducing the aromatic monomer(s) used to form ester repeating units (e.g., aromatic hydroxycarboxylic acid, aromatic dicarboxylic acid, etc.) and/or other repeating units (e.g., aromatic dial, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 300° C. to about 400° C. For instance, one suitable technique for forming the liquid crystalline polymer may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 300° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 250° C. to about 350° C. The polymerization time will of course vary based on the temperature and target molecular weight. In most cases, however, the solid-state polymerization time will be from about 2 to about 12 hours, and in some embodiments, from about 4 to about 10 hours.

The resulting liquid crystalline polymer typically has a high molecular weight as is reflected by its melt viscosity. That is, the polymer, as well as the polymer composition itself, may have a melt viscosity of from about 20 to about 250 Pa-s, in some embodiments from about 25 to about 220 Pa-s, and in some embodiments, from about 30 to about 200 Pa-s, determined at a shear rate of 1000 seconds⁻¹. Melt viscosity may be determined in accordance with ISO Test No. 11443 at 15° C. higher than the melting temperature of the composition. The polymer may also have a complex viscosity of from about 2,500 to about 30,000 Pa-s, in some embodiments from about 5,000 to about 25,000 Pa-s, and in some embodiments, from about 10,000 to about 20,000 Pa-s, determined at angular frequencies ranging from 0.1 to 500 radians per second (e.g., 0.1 radians per second). The complex viscosity may be determined by a parallel plate rheometer at 15° C. above the melting temperature and at a constant strain amplitude of 1%.

The melt strength of the polymer may also be relatively high, which can be characterized by the engineering stress and/or viscosity at a certain percent strain and at the melting temperature of the composition. As explained in more detail below, such testing may be performed in accordance with the ARES-EVF during which an extensional viscosity fixture (“EVF”) is used on a rotational rheometer to allow the measurement of the material stress versus percent strain. In this regard, the polymer can have a relatively high maximum engineering stress even at relatively high percent strains. For example, the polymer can exhibit its maximum engineering stress at a percent strain of from about 0.3% to about 1.5%, in some embodiments from about 0.4% to about 1.5%, and in some embodiments, from about 0.6% to about 1.2%. The maximum engineering stress may, for instance, range from about 150 kPa to about 370 kPa, in some embodiments from about 250 kPa to about 360 kPa, and in some embodiments, from about 300 kPa to about 350 kPa. The elongational viscosity may also range from about 50 kPa-s to about 300 kPa-s, in some embodiments from about 80 kPa-s to about 250 kPa-s, and in some embodiments, from about 100 kPa-s to about 200 kPa-s. Without intending to be limited by theory, the ability to achieve enhanced such an increased melt strength can allow the resulting composition to better maintain its shape during melt extrusion without exhibiting a substantial amount of sag.

The polymer can also have a relatively high storage modulus. The storage modulus of the polymer, for instance, may be from about 1 to about 800 Pa, in some embodiments from about 2 to about 700 Pa, and in some embodiments, from about 5 to about 600 Pa, as determined at the melting temperature of the composition and at an angular frequency of 0.1 radians per second. The polymer may also have a solidification rate and/or crystallization rate that allows for extruding without producing tears, ruptures, stress fractures, blisters, etc. In this regard, the polymer may have a relatively high heat of crystallization, such as about 3.3 J/g or more, in some embodiments about 3.5 J/g or more, in some embodiments from about 3.5 to about 10 J/g, and in some embodiments, from about 3.7 to about 6.0 J/g. As used herein, the heat of crystallization is determined according to ISO Test No. 11357. The melting temperature of the liquid crystalline polymer may likewise range from about 300° C. to about 400° C., in some embodiments from about 310° C. to about 395° C., and in some embodiments, from about 320° C. to about 380° C. (e.g., 360° C.). The melting temperature may be determined as is well known in the art using differential scanning calorimetry (“DSC”), such as determined by ISO Test No. 11357.

B. Non-Metallic Filler

As indicated above, the polymer composition contains at least one non-metallic filler. Non-metallic fillers may, for instance, be employed in the polymer composition to help achieve the desired mechanical properties and/or appearance. When employed, non-metallic fillers typically constitute from about 1 wt. % to about 60 wt. %, in some embodiments from about 5 wt. % to about 55 wt. %, and in some embodiments, from about 6 wt. % to about 30 wt. % of the polymer composition.

Clay minerals may be particularly suitable for use as non-metallic fillers in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K, H₃O)(Al, Mg, Fe)₂ (Si,Al)₄O₁₀[(OH)₂,(H₂O)]), montmorillonite (Na, Ca)_{0.33}(Al, Mg)₂Si₄O₁₀(OH)₂.nH₂O), vermiculite ((MgFe, Al)₃(Al, Si)₄O₁₀(OH)₂.4H₂O), palygorskite ((Mg, Al)₂Si₄O₁₀(OH).4(H₂O)), pyrophyllite (Al₂Si₄O₁₀(OH)₂), etc., as well as combinations thereof. In lieu of, or in addition to, clay minerals, still other particulate fillers may also be employed. For example, other suitable silicate fillers may also be employed, such as calcium silicate, aluminum silicate, mica, diatomaceous earth, wollastonite, and so forth. Mica, for instance, may be a particularly suitable mineral for use in the present invention. There are several chemically distinct mica species with considerable variance in geologic occurrence but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K, Na)(Al, Mg, Fe)₂(Si, Al)₄O₁₀(OH)₂), etc., as well as combinations thereof. When employed, mineral fillers typically constitute from about 10 wt. % to about 60 wt. %, in some embodiments from about 10 wt. % to about 55 wt. %, and in some embodiments, from about 10 wt. % to about 30 wt. % of the polymer composition.

Fibers may also be employed as a non-metallic filler to further improve the mechanical properties. Such fibers generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 to about 10,000 MPa, and in some embodiments, from about 3,000 to about 6,000 MPa. Examples of such fibrous fillers may include those formed from glass, carbon, ceramics (e.g., alumina or silica), aramids (e.g., Kevlar® marketed by E.I. DuPont de Nemours, Wilmington, Del.), polyolefins, polyesters, etc., as well as mixtures thereof. Glass fibers are particularly suitable, such as E-glass, A-glass, C-glass, D-glass, AR-glass, R-glass, S2-glass, etc., as well as combinations thereof. Particulate fillers may also be employed in the polymer composition to help achieve the desired properties and/or color. Other configurations of glass fillers include beads, flakes, and microspheres.

The volume average length of the fibers may be from about 50 to about 400 micrometers, in some embodiments from about 80 to about 250 micrometers, in some embodiments from about 100 to about 200 micrometers, and in some embodiments, from about 110 to about 180 micrometers. The fibers may also have a narrow length distribution. That is, at least about 70% by volume of the fibers, in some embodiments at least about 80% by volume of the fibers, and in some embodiments, at least about 90% by volume of the fibers have a length within the range of from about 50 to about 400 micrometers, in some embodiments from about 80 to about 250 micrometers, in some embodiments from about 100 to about 200 micrometers, and in some embodiments, from about 110 to about 180 micrometers. The fibers may also have a relatively high aspect ratio (average length divided by nominal diameter) to help improve the mechanical properties of the resulting polymer composition. For example, the fibers may have an aspect ratio of from about 2 to about 50, in some embodiments from about 4 to about 40, and in some embodiments, from about 5 to about 20 are particularly beneficial. The fibers may, for example, have a nominal diameter of about 10 to about 35 micrometers, and in some embodiments, from about 15 to about 30 micrometers. The relative amount of the fibers in the polymer composition may also be selectively controlled to help achieve the desired mechanical properties without adversely impacting other properties of the composition, such as its flowability. For example, the fibers may constitute from about 2 wt. % to about 40 wt. %, in some embodiments from about 5 wt. % to about 35 wt. %, and in some embodiments, from about 6 wt. % to about 30 wt. % of the polymer composition.

C. Metallic Filler

In accordance with the present invention, the polymer composition also contains at least one metallic filler. The metallic filler may be magnetically permeable, which increases the detectability of the film in the composition by a metal detector. The permeability “μ” of the filler is the measure of the ability of the filler to support the formation of a magnetic field within itself and may be, for instance, about 1×10⁻⁵ or more, in some embodiments about 1×10⁻⁴ or more, and in some embodiments, from about 5×10⁻⁴ to about 1×10⁻¹ H/m, where H is the magnetic dipole density. For instance, the metallic filler may contain finely divided magnetically permeable materials in the form of particles, fibers, flakes, or combinations thereof. Examples of such metallic fillers may include stainless steel, ferrous materials such as black iron oxide (Fe₃O₄), magnetite, carbonyl iron, copper, aluminum, nickel, permalloy, etc., as well as mixtures thereof. Particularly suitable are stainless steel fibers or powders, which may have a ferromagnetic content of about 90 wt. % or more, in some embodiments about 95 wt % or more, and in some embodiments, from about 98 wt % to 100 wt. %. Suitable stainless steel fillers include those comprised of a grade 300-series austenitic or grade 400-series ferritic or martensitic stainless steels, or combinations thereof, as defined by the American Iron and Steel Institute (AISI). Suitable commercially available magnetic fillers include those such as POLYMAG from Eriez Magnetics; Beki-Shield BU08/5000 CR E, Beki-Shield BU08/12000 CR E, and/or BU11/7000 CR E P-BEKRT from Bekaert; PPO-1200-NiCuNi, PPO-1200-NiCu, and/or PPO-1200-Ni from Composite Material; G30-500 12K A203 MC from Toho Carbon Fiber; INCOFIBER® 12K20 and/or INCOFIBER® 12K50 from Inco Special Products; Novamet Stainless Steel Flakes from Novamet Specialty Products.

When the metallic filler is in the form of particles, the mean particle size may be from about 0.5 microns to about 100 microns, in some embodiments from about 0.7 microns to about 75 microns, and in some embodiments, from about 1 micron to about 50 microns. In addition, the particles may have a mean particle size such that at least about 90% of the particles pass through a 150 mesh (105 microns), in some embodiments at least about 95%, and in some embodiments, at least about 98%. Stainless steel particles may have a mean particle size such that at least about 90% of the particles pass through a 325 mesh (44 microns), in some embodiments at least about 95%, and in some embodiments, at least about 98%. Likewise, when metallic flakes are employed, the flakes may have a thickness of from about 0.4 to about 1.5 microns, in some embodiments from about 0.5 to about 1 micron, and in some embodiments, from about 0.6 to 0.9 microns. In addition, the flakes may have a size such that at least about 85% of the particles pass through a 325 mesh (44 microns), in some embodiments at least about 90%, and in some embodiments, at least about 95%. Further, metallic fibers may also have a diameter of from about 1 micron to about microns, in some embodiments from about 2 to about 15 microns, and in some embodiments, from about 3 to about 10 microns. The fibers may also have an initial length of from about 2 to about 30 mm, in some embodiments from about 3 to about 25 mm, and in some embodiments from about 4 to about 20 mm. The final length of the fibers may depend upon any fiber breakage that may occur during compounding, extruding, and/or molding. These processes are typically optimized to reduce fiber length attrition and hence improve electrical conductivity and detectability.

In forming the polymer composition, the metallic filler may be pre-compounded with the polymer, added with the polymer to the extruder, added downstream from the extruder inlet after a polymer melting section, etc. In one particular embodiment, for example, the metallic filler may be incorporated into the composition by mixing and melt processing the composition with a concentrate. The concentrate may contain from about 10 wt. % to about 60 wt. %, in some embodiments from about 25 wt. % to about 55 wt. %, and in some embodiments from about 30 wt. % to about 52 wt. % metallic filler. The concentrate may be produced by chopping continuous, thermoplastic strands as impregnated rovings via pultrusion which is known in the art. The conventional pultrusion process may be adapted by feeding a plurality of metallic fillers, such as stainless steel fiber ravings, from spools whereby the bundled rovings are spread, pre-heated, and pulled through an impregnation die charged with a melt comprising a liquid crystalline polymer at a temperature above the polymer melting temperature and below the polymer degradation temperature. A variety of impregnation dies may be used, such as those containing staggered guide pins, interweaving upper and lower die sections that form a tortuous path in the central opening, or wave dies. The die exit gap can be adjusted to control the polymer content. The impregnated, spread fiber bundles proceed through the die within about 1 to 10 seconds depending on the line speed and are then advanced through a plurality of rotating shaping dies to form circular cross-sections (e.g., rods) which are then cooled. The impregnated rod bundles engage the puller and are cut perpendicular to the machine direction. After the impregnated tows exit the die, they are consolidated by circular-cross section shaping rollers, engaged with the puller, and advanced through a rotary wheel chopper. The strands may be chopped to a preselected length providing a rod-shaped pellet having a fiber length approximately equal to the pellet length and ranging from about 2 to about 25 mm, in some embodiments from about 3 to about 18 mm, and in some embodiments from about 4 to about 12 mm.

As described above, the metallic filler is present in the polymer composition in an amount sufficient for the resulting product to be metal detectable. As used herein, the term “metal detectable” may refer to a composition that exhibits a gauge signal strength (proportional to a voltage signal of the composition) of greater than or equal to 500 above a background signal (threshold) at a preselected frequency from 40 to 900 kHz using a Lorna IQ³ metal detector with a 150 mm aperture. The background signal or threshold represents the signal contribution from the food, detector, and its operating environment. The above metal detector generally includes a transmitter coil and a receiver coil. A magnetic field is created by an oscillator that results in coupling between the transmitter coil and typically two receiver coils. The two receiver coils are typically placed the same distance from the transmitter coil and thus produce a similar output voltage. When the coils are connected in opposition, the output is canceled resulting in a zero value. When a metallic filler passes through the aperture in the detector, the high frequency field is disturbed causing a change in the voltage and thus producing a signal.

The optimum loading may be dependent upon the type, size, and geometry of the metallic filler, the other components contained in the polymer composition, the type of food being tested, and the sensitivity of the metal detector used in the process. In this regard, the metallic filler may constitute from about 1.5 wt % to about 15 wt. %, in some embodiments from about 2 wt. % to about 12 wt. %, and in some embodiments from about 3 wt % to about 10 wt. % of the polymer composition. The above loading range may be sufficient to afford reliable detection by a metal detector without triggering false alarms or rejections. When the amount of metallic filler is too low, the filler may not be detectable because it provides insufficient signal strength above the background signal. When the amount of metallic filler is too high, the durability and/or strength of the resultant product may be reduced.

D. Optional Additives

The composition may optionally contain one or more additives if so desired, such as flow aids, antimicrobials, pigments, antioxidants, stabilizers, surfactants, waxes, solid solvents, flame retardants, anti-drip additives, and other materials, such as polytetrafluoroethylene and silicone, added to enhance properties and processability. When employed, the optional additive(s) typically constitute from about 0.05 wt. % to about 5 wt. %, in some embodiments, from about 0.1 wt. % to about 3.5 wt. %, and in some embodiments, from about 0.15 wt. % to about 1.5 wt. % of the composition.

The resulting polymer composition may have a relatively high melting temperature. For example, the melting temperature of the polymer composition may be from about 300° C. to about 400° C., in some embodiments from about 310° C. to about 395° C., and in some embodiments, from about 320° C. to about 380° C. Even at such melting temperatures, the ratio of the deflection temperature under load (“DTUL”), a measure of short term heat resistance, to the melting temperature may still remain relatively high. For example, the ratio may range from about 0.67 to about 1.00, in some embodiments from about 0.68 to about 0.95, and in some embodiments, from about 0.70 to about 0.85. The specific DTUL values may, for instance, range from about 200° C. to about 350° C., in some embodiments from about 210° C. to about 320° C., and in some embodiments, from about 220° C. to about 290° C. The polymer composition may also possess a relatively high degree of heat resistance. For example, the composition may possess a “blister free temperature” of about 250° C. or greater, in some embodiments about 260° C. or greater, in some embodiments from about 265° C. to about 320° C., and in some embodiments, from about 270° C. to about 300° C. As explained in more detail below, the “blister free temperature” is the maximum temperature at which a substrate does not exhibit blistering when placed in a heated silicone oil bath. Such blisters generally form when the vapor pressure of trapped moisture exceeds the strength of the substrate, thereby leading to delamination and surface defects.

### II. Melt Extrusion

The polymer composition of the present invention is generally melt-extruded into a substrate, which can then be used alone or in a wide variety of different articles. The substrate is typically in the form of a thin sheet having a thickness of from about 0.5 millimeters to about 20 millimeters, in some embodiments from about 0.6 to about 15 millimeters, and in some embodiments, from about 1 to about 10 millimeters. Any of a variety of melt extrusion techniques may generally be employed to form a sheet from the polymer composition of the present invention. Suitable melt extrusion techniques may include, for instance, tubular trapped bubble film processes, flat or tube cast film processes, slit die flat cast film processes, etc. Referring to FIG. 4, for instance, one embodiment of a melt extrusion process is shown in more detail. As illustrated, the components of the polymer composition (e.g., polymer, fillers, and any optional additives) may be initially fed to an extruder 110 that heats the composition to a temperature sufficient for it to flow. In one embodiment, the polymer may be initially fed to an extruder 110 and the non-metallic and/or metallic filler may be fed downstream after a polymer melting section. In another embodiment, the non-metallic filler and/or metallic filler may be pre-compounded with the polymer before being introduced to the extruder.

In one embodiment, the polymer composition is heated to a temperature that is at the melting temperature of the polymer composition or within a range of about 20° C. above or below the melting temperature of the polymer composition. The extruder 110 produces a precursor sheet 112. Before having a chance to solidify, the precursor sheet 112 may be fed into a nip of a calendering device 114 to form a polymeric sheet have a more uniform thickness. The calendering device 114 may include, for instance, a pair of calendering rolls that form the nip. Once calendered, the resulting polymeric sheet may optionally be cut into individual sheets 118 using a cutting device 116. The sheets formed according to the process described above generally have a relatively large surface area in comparison to their thickness. As described above, for instance, the thickness of the sheets may be about 0.5 millimeters or more, in some embodiments from about 0.6 to about 20 millimeters, and in some embodiments, from about 1 to about 10 millimeters. The surface area of one side of the polymeric sheets may likewise be greater than about 900 cm², such as greater than about 2000 cm², such as greater than about 4000 cm². In one embodiment, for instance, the surface area of one side of the polymeric sheet may be from about 1000 cm² to about 6000 cm². Alternatively, the polymer composition may also be pelletized.

As indicated above, the present inventors has discovered that the polymer composition is uniquely both highly melt processible and stretchable, which allows the resulting substrate to be more readily formed into articles without sacrificing the desired thermal and/or mechanical properties. The tensile and flexural mechanical properties of the substrate are also good. For example, the substrate may exhibit a flexural strength of from about 20 to about 500 MPa, in some embodiments from about 40 to about 200 MPa, and in some embodiments, from about 50 to about 150 MPa; a flexural break strain of about 0.5% or more, in some embodiments from about 0.6% to about 10%, and in some embodiments, from about 0.8% to about 3.5%; and/or a flexural modulus of from about 2,000 to about 20,000 MPa, in some embodiments from about 3,000 to about 20,000 MPa, and in some embodiments, from about 4,000 to about 15,000 MPa. The flexural properties may be determined in accordance with ISO Test No. 178 (technically equivalent to ASTM D790-98) at 23° C. The tensile strength may also be from about 20 to about 500 MPa, in some embodiments from about 50 to about 400 MPa, and in some embodiments, from about 100 to about 350 MPa; a tensile elongation of about 0.5% or more, in some embodiments from about 0.6% to about 10%, and in some embodiments, from about 0.8% to about 3.5%; and/or a tensile modulus of from about 5,000 to about 20,000 MPa, in some embodiments from about 8,000 to about 20,000 MPa, and in some embodiments, from about 10,000 to about 15,000 MPa. The tensile properties may be determined in accordance with ISO Test No. 527 (technically equivalent to ASTM D638) at 23° C.

The toughness of the substrate may also be good, which can be an important attribute, for example, in bakeware articles. The substrate may, for example, have a multi-axial impact load (according to ASTM Test No. 3763) of greater than about 700 N at ambient temperature (23° C.), such as greater than about 800 N at ambient temperature, and at least about 500 N at 170° C. For example, in one embodiment, the substrate can have a multi-axial impact load of from about 700 to about 8000 N at ambient temperature and from about 500 to about 5000 N at 170° C. The substrate may also have a notched Izod impact of at least about 3 kJ/m², such as from about 3 kJ/m² to about 60 kJ/m′

### III. Articles

While any of a variety of articles may be formed from the polymer composition of the present invention, three-dimensional thermoformed articles are particularly suitable. Such articles may be formed by heating the melt-extruded substrate to a certain temperature so that it becomes flowable, shaping the substrate within a mold, and then optionally trimming the shaped article to create the desired article. For example, a substrate may be clamped inside a thermoformer and heated (e.g., with infrared heaters) to a temperature of slightly above 350° C. Depending on the type of machine used, the substrate may be transferred to a forming station or the bottom heating elements may be moved for the forming tool to be able to form the sheet. The forming tool (e.g., aluminum) may be heated to about 120° C. to about 200° C. Different thermoforming techniques can be successfully used, such as vacuum forming, plug-assist vacuum forming, pressure forming, reverse draw, twin sheet thermoforming and others. Once the forming step is completed, the part can be trimmed.

Referring to FIG. 5, for example, one particular embodiment of a thermoforming process is shown in more detail. As illustrated, the polymeric sheet 118 is first fed to a heating device 120 that heats it to a temperature sufficient to cause the polymer to deform or stretch. In general, any suitable heating device may be used, such as a convection oven, electrical resistance heater, infrared heater, etc. Once heated, the polymeric sheet 118 is fed to a molding device 122 where it is molded into an article. Any of a variety of molding devices may be employed in the thermoforming process, such as a vacuum mold. Regardless, a force (e.g., suction force) is typically placed against the sheet to cause it to conform to the contours of the mold. At the contours, for instance, the draw ratio may be greater than 1:1 to about 5:1. Molding of the polymeric sheet 118 typically occurs before the sheet substantially solidifies and/or crystallizes. Thus, the properties of the polymer are not only important during production of the polymeric sheets 118, but are also important during the subsequent molding process. If the polymeric sheet 118 were to solidify and/or crystallize too quickly, the polymer may tear, rupture, blister or otherwise form defects in the final article during molding.

The resulting article may, for example, be a package, container, tray (e.g., for a food article), electrical connector, bottle, pouch, cup, tub, pail, jar, box, engine cover, aircraft part, circuit board, etc. Although any suitable three-dimensional article can be formed, the melt-extruded sheet of the present invention is particularly well suited to producing cooking articles, such as cookware and bakeware. For example, when formed in accordance with the present invention, such articles can be capable of withstanding very high temperatures, including any oven environment for food processing. The articles are also chemical resistant and exceptionally inert. The articles, for instance, may be being exposed to any one of numerous chemicals used to prepare foods and for cleaning without degrading while remaining resistant to stress cracking. In addition, the articles may also possess excellent anti-stick or release properties. Thus, when molded into a cooking article, no separate coatings may be needed to prevent the article from sticking to food items. In this manner, many bakery goods can be prepared in cookware or bakeware without having to grease the pans before baking, thus affording a more sanitary working environment. The sheet also greatly reduces or eliminates a common issue of trapped food or grease in corners of rolled metal pans as solid radius corners can be easily incorporated into cookware.

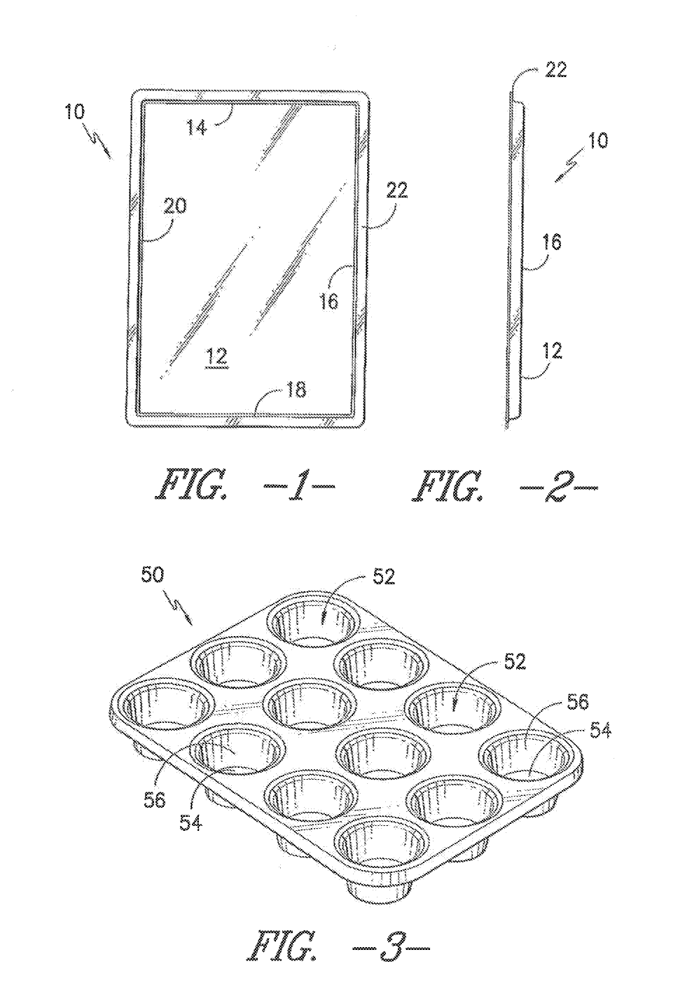

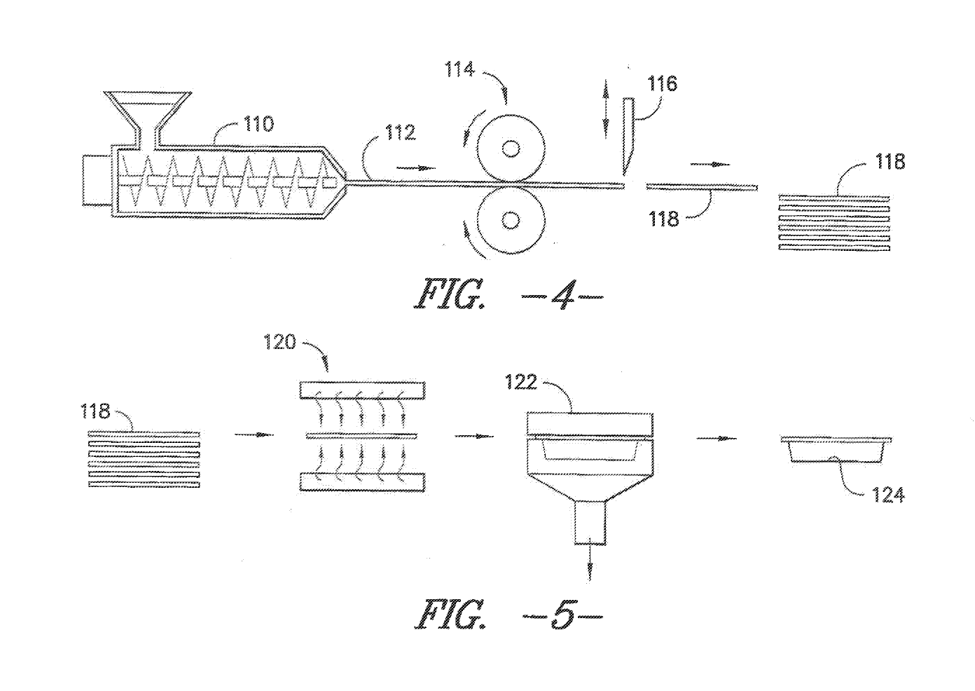

The types of cooking articles can vary dramatically depending upon the particular application. The melt-extruded sheet may, for instance, be used to produce bakeware, cookware, and any suitable parts that may be used in food processing equipment, such as cake pans, pie pans, cooking trays, bun pans, cooking pans, muffin pans, bread pans, etc. For exemplary purposes only, various different cookware articles that may be made in accordance with the present disclosure are illustrated in FIGS. 1-3. Referring to FIGS. 1-2, for instance, one embodiment of a cooking pan or tray 10 is shown that includes a bottom surface 12 that is surrounded by a plurality of walls 14, 16, 18 and 20. The bottom surface 12 is configured to receive a food item for preparation and/or serving. The side wall 16 forms a contour that transitions into the bottom surface 12. In the illustrated embodiment, the tray 10 is also surrounded by a lip or flange 22. The flange 22 may have any desired shape and/or length that assists in holding the tray during food preparation and/or when the tray is hot. An alternative embodiment of a cookware article is also shown in FIG. 3 that contains a muffin pan 50. The muffin pan 50 contains a plurality of cavities 52 for baking various food articles, such as muffins or cupcakes. As shown, each cavity 52 includes a bottom surface 54 surrounded by a circular wall 56. The muffin pan 50 can have overall dimensions similar to the cooking tray 10.

The present disclosure may be better understood with reference to the following examples.

Test Methods

Melt Viscosity:

The melt viscosity (Pa·s) may be determined in accordance with ISO Test No. 11443 at a shear rate of 1000 seconds⁻¹ and temperature 15° C. above the melting temperature (e.g., about 370° C. or 375° C.) using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

Complex Viscosity:

Complex viscosity is a frequency-dependent viscosity, determined during forced harmonic oscillation of shear stress at angular frequencies of 0.1 to 500 radians per second. Prior to testing, the sample is cut into the shape of a circle (diameter of 25 mm) using a hole-punch. Measurements may be determined at a temperature 15° C. above the melting temperature (e.g., about 375° C.) and at a constant strain amplitude of 1% using an ARES-G2 rheometer (TA Instruments) with a parallel plate configuration (25 mm plate diameter). The gap distance for each sample is adjusted according to the thickness of each sample.

Melting Temperature:

The melting temperature (“Tm”) may be determined by differential scanning calorimetry (“DSC”) as is known in the art. The melting temperature is the differential scanning calorimetry (DSC) peak melt temperature as determined by ISO Test No. 11357. Under the DSC procedure, samples were heated and cooled at 20° C. per minute as stated in ISO Standard 10350 using DSC measurements conducted on a TA Q2000 Instrument.

Melt Elongation:

Melt elongation properties (i.e., stress, strain, and elongational viscosity) may be determined in accordance with the ARES-EVF: Option for Measuring Extensional Velocity of Polymer Melts, A. Franck, which is incorporated herein in its entirety by reference thereto for all purposes. In this test, an extensional viscosity fixture (“EVF”) is used on a rotational rheometer to allow the measurement of the engineering stress at a certain percent strain. More particularly, a thin rectangular polymer melt sample is adhered to two parallel cylinders: one cylinder rotates to wind up the polymer melt and lead to continuous uniaxial deformation in the sample, and the other cylinder measures the stress from the sample. An exponential increase in the sample length occurs with a rotating cylinder. Therefore, the Hencky strain (ε_{H}) is determined as function of time by the following equation: ε_{H}(t)=In(L(t)/Lₒ), where Lₒ is the initial gauge length of and L(t) is the gauge length as a function of time. The Hencky strain is also referred to as percent strain. Likewise, the elongational viscosity is determined by dividing the normal stress (kPa) by the elongation rate (s⁻¹). Specimens tested according to this procedure have a width of 1.27 mm, length of 30 mm, and thickness of 0.8 mm. The test may be conducted at the melting temperature (e.g., about 360° C.) and elongation rate of 2 s⁻¹.

Flexural Modulus, Flexural Stress, and Flexural Strain:

Flexural properties may be determined according to ISO Test No. 178 (technically equivalent to ASTM D790-98). This test may be performed on a 64 mm support span. Tests may be run on the center portions of uncut ISO 3167 multi-purpose bars. The testing temperature may be 23° C. and the testing speed may be 2 mm/min.

Tensile Strength, Tensile Elongation, and Tensile Modulus:

The tensile properties may be determined in accordance with ISO 527 (technically equivalent to ASTM D638). The testing temperature may be 23° C.

Flexural Modulus and Flexural Stress:

Flexural properties are tested according to ISO Test No. 178 (technically equivalent to ASTM D790). This test is performed on a 64 mm support span. Tests are run on the center portions of uncut ISO 3167 multi-purpose bars. The testing temperature is 23° C. and the testing speed is 2 mm/min.

Notched Charpy Impact Strength:

Notched Charpy properties are tested according to ISO Test No. ISO 179-1) (technically equivalent to ASTM D256, Method B). This test is run using a Type A notch (0.25 mm base radius) and Type 1 specimen size (length of 80 mm, width of 10 mm, and thickness of 4 mm). Specimens are cut from the center of a multi-purpose bar using a single tooth miffing machine. The testing temperature is 23° C.

Unnotched Charpy Impact:

The unnotched Charpy impact may be determined in accordance with ISO 179. The unnotched Charpy impact measures the resistance to impact from a swinging pendulum. The test measures the energy needed to initiate fracture and continue until the specimen is broken.

Multi-Axial Impact:

Multi-axial impact may be determined in accordance with ASTM 3763. The testing temperature may be 23° C. and 170° C. The multi-axial impact provides a measure of toughness, load-deflection curves, and total energy absorption of impacts generally at high velocities.

Deflection Under Load Temperature (“DTUL”):

The deflection under load temperature may be determined in accordance with ISO Test No. 75-2 (technically equivalent to ASTM D648-07). More particularly, a sample having a length of 80 mm, thickness of 10 mm, and width of 4 mm may be subjected to an edgewise three-point bending test in which the specified load is 1.8 MPa. The specimen may be lowered into a silicone oil bath where the temperature is raised at 2° C. per minute until it deflects 0.25 mm (0.32 mm for ISO Test No. 75-2).

Blister Free Temperature:

To test blister resistance, a 127×12.7×0.8 mm test substrate is formed at 5° C. to 10° C. higher than the melting temperature of the polymer resin, as determined by DSC. Ten (10) substrates are immersed in a silicone oil at a given temperature for 3 minutes, subsequently removed, cooled to ambient conditions, and then inspected for blisters (i.e., surface deformations) that may have formed. The test temperature of the silicone oil begins at 250° C. and is increased at 10° C. increments until a blister is observed on one or more of the test substrates. The “blister free temperature” for a tested material is defined as the highest temperature at which all ten (10) bars tested exhibit no blisters. A higher blister free temperature suggests a higher degree of heat resistance.

Metal Detection:

Metal detection may be conducted on a Loma IQ³ metal detector using a 150 mm aperture at a frequency of 300 kHz. When conducting a background test, a white bread, detector, and surrounding provided a total signal or threshold of about 1120. Therefore, a specimen signal strength may be set to 500 units above the threshold to account for a variation in signals due to food type, temperature, salt content, humidity, and any drift.

### Example 1

A liquid crystalline polymer may be melt-polymerized from 4-hydroxybenzoic acid (“HBA”). 2,6-hydroxynaphthoic acid (“HNA”), terephthalic acid (“TA”), 4,4′-biphenol (“BP”), and acetaminophen (“APAP”), such as described in U.S. Pat. No. 5,508,374 to Lee, et al. The naphthenic content may be 5 mol. %. The melt-polymerized polymer may then be solid-state polymerized until a relatively high melt viscosity is achieved. One sample of the high molecular weight LCP may be formed. To form the sample, pellets of the liquid crystalline polymer are dried at 150° C. overnight. Thereafter, the polymer is supplied to the feed throat of a ZSK-25 WLE co-rotating, fully intermeshing twin screw extruder in which the length of the screw is 750 millimeters, the diameter of the screw is 25 millimeters, and the L/D ratio is 30. Once melt blended, the samples are extruded through a single-hole strand die, cooled through a water bath, and pelletized. The melt viscosity and melting temperature of the sample is set forth below in Table 1. The rheological properties of the polymer pellets are also set forth below in Table 2.

TABLE 1
Melt Viscosity and Melting Temperature

| | High MW LCP |
|---|---|
| Melt Viscosity (at 1000/sec, ~ 375° C.) (Pa · s) | 173.7 |
| Melt Viscosity (at 400/s, ~ 375° C.) (Pa · s) | 368.4 |
| Melting Temperature (° C.) | 356 |

TABLE 2
Rheological Behavior of High MW LCP Sample

| Angular frequency | Storage modulus | Loss modulus | Complex viscosity |
|---|---|---|---|
| (rad/s) | (Ps) | (Pa) | (Pa · s) |
| 0.1 | 527.1 | 1331.3 | 14318.5 |
| 0.2 | 738.0 | 1921.6 | 12987.6 |
| 0.3 | 1025.9 | 2813.6 | 11922.6 |
| 0.4 | 1464.3 | 4151.4 | 11057.6 |
| 0.6 | 2237.2 | 6113.4 | 10317.5 |
| 1.0 | 3605.7 | 8865.6 | 9570.8 |
| 1.6 | 6011.0 | 12467.2 | 8732.8 |
| 2.5 | 9907.6 | 16674.7 | 7721.7 |
| 4.0 | 15649.0 | 20994.1 | 6577.3 |
| 6.3 | 23076.5 | 24761.9 | 5364.5 |
| 10.0 | 31740.7 | 27518.1 | 4200.9 |
| 15.8 | 40941.3 | 29113.5 | 3169.8 |
| 25.1 | 50089.8 | 29833.2 | 2321.0 |
| 39.3 | 58867.2 | 30167.9 | 1661.5 |
| 63.1 | 67307.2 | 30645.9 | 1172.1 |
| 100.0 | 75674.6 | 31670.9 | 820.3 |
| 158.5 | 84209.9 | 33514.4 | 571.9 |
| 251.2 | 93525.6 | 36287.3 | 399.4 |
| 398.1 | 103797.0 | 39789.3 | 279.2 |
| 500.0 | 109454.0 | 41872.7 | 234.4 |

### Example 2

A polymer composition is formed that contains 90.0 wt. % of the liquid crystalline polymer of Example 1, 6.0 wt. % of a metal detectable concentrate, and 4.0 wt. % of a black color masterbatch. The metal detectable concentrate is formed from 50 wt. % of PolMag stainless steel powder from Eriez Magnetics in Vectra E950i polymer.

### Example 3

A polymer composition is formed that contains 86.0 wt. % of the liquid crystalline polymer of Example 1, 10.0 wt. % of the metal detectable concentrate of Example 2, and 4.0 wt % of a black color masterbatch.

### Example 4

A polymer composition is formed that contains 76.0 wt. % of the liquid crystalline polymer of Example 1, 10.0 wt. % of the metal detectable concentrate of Example 2, 10 wt. % talc, and 4.0 wt. % of a black color masterbatch.

Parts are injection molded from the compositions of Examples 2-4 and tested for thermal and mechanical properties as described above. The results are set forth below.

| | Example 2 | Example 3 | Example 4 |
|---|---|---|---|
| Tensile Modulus (MPa) | 12,816 | 12,397 | 11,941 |
| Tensile Strength (MPa) | 143.25 | 140.87 | 140.41 |
| Break Strain (%) | 1.76 | 1.87 | 2.32 |
| Flexural Modulus (MPa) | 11,564 | 11,699 | 11,758 |
| Flexural Strength (MPa) | 148.36 | 148.63 | 144.22 |
| Flexural Strain (%) | 2.82 | 2.92 | 3.12 |
| Charpy Impact Unnotched (kJ/m²) | 74.7 | 75.6 | 55.5 |
| Charpy impact notched (KJ/m2) | 36.1 | 36.3 | 30.7 |
| DTUL (° C.) at 1.8 MPa | 255.1 | 256.3 | 252.7 |
| Melt Viscosity at 400 s⁻¹ | 52.7 | 53.2 | 61.0 |
| at 370° C. (Pa · s) | | | |
| Melt Viscosity at 1000 s⁻¹ | 35.2 | 36.4 | 41.6 |
| at 370° C. (Pa · s) | | | |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A metal detectable, melt-extrudable polymer composition comprising from about 25 wt. % to about 98 wt. % of a thermotropic liquid crystalline polymer, from about 1 wt. % to about 60 wt. % of a non-metallic filler, from about 1 wt % to about 15 wt. % of a metallic filler, wherein the polymer exhibits a melt viscosity of from about 20 to about 250 Pa-s, determined at a shear rate of 1000 s⁻¹ in accordance with ISO Test No. 11443 at 15° C. higher than the melting temperature of the composition.

2. The polymer composition of claim 1, wherein the polymer exhibits a melt viscosity of from about 30 to about 200 Pa-s, as determined in accordance with ISO Test No. 11443 at 15° C. higher than the melting temperature of the composition and at a shear rate of 1000 seconds⁻¹.

3. The polymer composition of claim 1, wherein the polymer exhibits a maximum engineering stress of from about 150 kPa to about 370 kPa, as determined at the melting temperature of the composition with an extensional viscosity fixture and a rotational rheometer.

4. The polymer composition of claim 1, wherein the polymer exhibits a maximum engineering stress at a percent strain of from about 0.3% to about 1.5%, as determined at the melting temperature of the composition with an extensional viscosity fixture and a rotational rheometer.

5. The polymer composition of claim 1, wherein the polymer exhibits an elongational viscosity of from about 50 kPa-s to about 300 kPa-s, as determined at the melting temperature of the composition with an extensional viscosity fixture and a rotational rheometer.

6. The polymer composition of claim 1, wherein the melting temperature of the polymer is from about 300° C. to about 400° C.

7. The polymer composition of claim 1, wherein the thermotropic liquid crystalline polymer contains aromatic ester repeating units, the aromatic ester repeating units including aromatic dicarboxylic acid repeating units and aromatic hydroxycarboxylic acid repeating units.

8. The polymer composition of claim 7, wherein the aromatic hydroxycarboxylic acid repeating units are derived from 4-hydroxybenzoic acid, 6-hydroxy-2-naphthoic acid, or a combination thereof.

9. The polymer composition of claim 7, wherein the aromatic dicarboxylic acid repeating units are derived from terephthalic acid, isophthalic acid, or a combination thereof.

10. The polymer composition of claim 7, wherein the thermotropic liquid crystalline polymer further contains aromatic diol repeating units.

11. The polymer composition of claim 10, wherein aromatic diol repeating units are derived from hydroquinone, 4,4′-biphenol, or a combination thereof.

12. The melt-extruded substrate of claim 7, wherein the liquid crystalline polymer is formed from repeating units derived from 4-hydroxybenzoic acid in an amount from about 10 mol. % to about 80 mol. %, repeating units derived from terephthalic acid and/or isophthalic acid in an amount from about 5 mol. % to about 40 mol. %, and repeating units derived from 4,4′-biphenol and/or hydroquinone in an amount from about 1 mol. % to about 30 mol. %.

13. The polymer composition of claim 7, wherein the non-metallic filler is a mineral filler.

14. The polymer composition of claim 13, wherein the nonmetallic filler includes talc.

15. The polymer composition of claim 7, wherein the metallic filler has a permeability “μ” of about 1×10⁻⁵ H/m or more, where H is the magnetic dipole density.

16. The polymer composition of claim 7, wherein the metallic filler contains stainless steel, a ferrous material, iron oxide, magnetite, carbonyl iron, copper, aluminum, nickel, permalloy, or a combination thereof.

17. The polymer composition of claim 7, wherein the metallic filler includes stainless steel.

18. The polymer composition of claim 17, wherein the stainless steel has a paramagnetic content of about 90 wt. % or more.

19. The polymer composition of claim 7, wherein the metallic filler is in the form of particles having a mean particle size of from about 0.5 to about 100 microns, flakes having a thickness of from about 0.4 to about 1.5 microns, and/or fibers having a diameter of from about 1 micron to about 20 microns.

20. The polymer composition of claim 7, wherein the composition produces a gauge signal strength of greater than or equal to 500 above a background signal at a frequency of 300 kHz using an IQ³ metal detector with a 150 mm aperture.

21. The polymer composition of claim 7, wherein the polymer composition exhibits a blister free temperature of about 250° C. or more.

22. A melt-extruded substrate comprising the polymer composition of claim 1, wherein the substrate has a thickness of from about 0.5 to about 20 millimeters.

23. A three-dimensional article that is shaped from the melt-extruded substrate of claim 22.

24. The three-dimensional article of claim 23, wherein the article is a cooking article.

25. A method for forming the melt-extruded substrate of claim 22, the method comprising:
extruding the polymer composition to form a precursor sheet; and
calendaring the precursor sheet to form the melt-extruded substrate.
